(19) United States
(12) Patent Application Publication
(10) Pub. No.: US 2017/0061082 A1
(43) Pub. Date: Mar. 2, 2017

(54) SERVICE RELAY METHOD CONSIDERING MATCHING DEGREE AND SYSTEM ACCORDING TO SAME

(71) Applicant: Jaeseok JEONG, Seoul (KR)

(72) Inventor: Jaeseok JEONG, Seoul (KR)

(21) Appl. No.: 15/305,080

(22) PCT Filed: Apr. 21, 2014
(86) PCT No.: PCT/KR2014/003446

§ 371 Date: Oct. 18, 2016

(51) Int. Cl. G06F 19/00; G06Q 50/22; G06Q 30/08

(52) U.S. Cl. CPC G06F 19/327; G06Q 30/08; G06Q 50/22

(57) ABSTRACT

The present invention relates to a relay service providing method for a connection between a consumer (e.g., a patient) and a provider (e.g., a hospital) on the basis of the Internet, and more particularly, to a service relay method considering a matching degree comprising: calculating a matching degree on the basis of various matters, such as a consumer's taste or requirements and a provider's merit or supply history, among matters irrespective of price; and connecting a consumer and a provider having a matching degree of a predetermined reference value or above, wherein the consumer side provides a bidding document to only providers having the matching degree of the predetermined reference value or above and compares the bidding document with a corresponding bid document so as to allow making a choice considering a cost and a service.

### TECHNICAL FIELD

The present invention relates to a relay service providing method for a connection between a consumer (for example, a patient) and a provider (for example, a hospital) on the basis of the Internet, and more particularly, to a service relay method considering a matching degree including: calculating a matching degree on the basis of various matters, such as a consumer's taste or requirements and a provider's merit or supply history, among matters irrespective of price; and connecting a consumer and a provider having a matching degree of a predetermined reference value or above, in which the consumer side provides a bidding document to only providers having the matching degree of the predetermined reference value or above and compares the bidding document with a corresponding bid document so as to allow making a choice considering a cost and a service.

### BACKGROUND ART

Generally, a medical service is performed such that when a user visits a medical facility and explains a desired treatment and details of a medical treatment, a person in charge of the medical facility gives a checkup and tells the patient about prescription and a medical procedure and when the user agrees with this, the treatment is performed.

However, this method has a problem in that once the user visits the medical facility, the choice range is narrow and it costs to receive the checkup and consultation for determining whether to receive the medical procedure.

Further, it is very difficult to select a medical facility to receive the medical treatment suitable for the user. The user has no choice but to determine using general information such as word of mouth, the Internet, or magazines.

Various information is provided to users of the Internet through the Internet in the related art. Therefore, the user may receive lots of information on the details of the medical service through the Internet. Further, the Internet may provide a service with some customized functions for a specific member.

However, it is difficult to find a service which figures out all conditions of an individual who wants to use the medical service and provides a service suitable for the individual, from the Internet service of the related art.

Further, the Internet is utilized for various purposes in the related art. The business development through the Internet is performed in various fields beyond simply providing information. For example, the various fields include B2B, B2C, electronic mall, an auction service, a customized service, and a reverse auction service.

The services of the related art are potally or professionally operated in individual fields. However, in a medical service field, it is difficult to find a service beyond simply providing information.

This is not only because a value of the Internet service is lowered due to an oversupply of the Internet service, but also because a field characteristic of the medical service is not represented.

In other words, in the medical service, the cost cannot be simply considered as a yardstick for determination like an auction or a reverse auction of the related art. The medical service is directly connected to a life or a health of the user so that it should be sufficiently considered.

That is, it is difficult for many general Internet users to conveniently use a medical service suitable for them.

In order to overcome the above-mentioned problems, a technology is suggested in Korean Unexamined Patent Application Publication No. 10-2003-0002561 (entitled Method for providing medical service using a Dutch auction). According to the related art, a medical service which is requested by a user is guided through a medical service provider which is capable of providing the service and information on the medical service provider which responds the request of the user is provided to the user so as to allow the user to select a suitable medical service provider.

However, according to the related art, the client and the hospital are connected simply in view of a price so that a quality of the service may be lowered according to price competition.

Therefore, a new relay service which considers a taste of a consumer and suitability of a provider is demanded so that the cost and the quality of the service match to some degree.

### DISCLOSURE

### Technical Problem

The present invention has been made in an effort to provide a relay service providing method for a connection between a consumer (e.g., a patient) and a provider (e.g., a hospital) on the basis of the Internet, and more particularly, to a service relay method considering a matching degree comprising: calculating a matching degree on the basis of various matters, such as a consumer's taste or requirements and a provider's merit or supply history, among matters irrespective of price; and connecting a consumer and a provider having a matching degree of a predetermined reference value or above, in which the consumer side provides a bidding document to only providers having the matching degree of the predetermined reference value or above and compares the bidding document with a corresponding bid document so as to allow making a choice considering a cost and a service.

### Technical Solution

In order to achieve the above object, an exemplary embodiment of the present invention provides a service relay system considering a matching degree which provides a service between specific service providers and a consumer who receives a service provided by an arbitrary provider through a management server, on the basis of on-line. The system includes: a consumer access authentication module which, when a consumer (netizen) requests Internet access using a terminal (hereinafter, referred to as a consumer terminal) of the consumer, approves the access of the consumer terminal and maintains an access state to perform bidirectional data communication; a consumer management module which allows inputting consumer information including poll/requirements in the management server through the consumer terminal which is accessed to the consumer access authentication module; a cooperative company access authentication module which, when a provider requests Internet access using a terminal (hereinafter, referred to as a provider terminal) of the provider, approves the access of the provider terminal and maintains an access state to perform bidirectional data communication; a cooperative company management module which allows inputting cooperative company information including PR information in the management server through the provider terminal which is accessed to the cooperative company access authentication module; a matching module which compares information stored in the consumer management module and the cooperative company management module to calculate a matching degree; a consumer/cooperative company auction performing module which performs bidding and tendering for bid in accordance with an auction procedure on the basis of the information of the consumer management module, the cooperative company management module, and the matching module; and a server central processing module which controls operations of the consumer management module, the cooperative company management module, the matching module, and the consumer/cooperative company auction proceeding module and a flowing direction of data.

In an exemplary embodiment of the present invention, preferably, the system may further include an informal consumer information board on which informal information on the requirements of the consumer is posted.

In an exemplary embodiment of the present invention, preferably, the consumer management module and the cooperative company management module may be configured by: an input module for inputting data; and an information DB for storing information of the consumer and the cooperative company.

In an exemplary embodiment of the present invention, preferably, the matching module may include: a first matching degree calculating module which calculates a matching degree on the basis of information stored in the consumer management module and information stored in the cooperative company management module; and a second matching degree calculating module which calculates a matching degree of detailed information in accordance with bidding details when a request according to bidding is generated by the consumer or the cooperative company.

Another exemplary embodiment of the present invention provides a service relay method considering a matching degree which provides a relay service between specific service providers and a consumer who receives a service provided by an arbitrary provider, on the basis of on-line. The method includes: a first step of making an agreement with a plurality of providers of every type of business in every field by contract in accordance with member joining through terminals which are used by the providers and a cooperative company access authentication module; a second step of obtaining PR information on a service which is provided to providers with whom the agreement is made through the first step and information on the cooperative company according to the agreement through the terminals which are used by the providers and the cooperative company input module to be created as databases in a cooperative company information DB; a third step of when an arbitrary consumer (netizen) accesses through the terminal which is used by the consumer and the consumer access authentication module and then select a type of business and a field of interest through the consumer input module, requesting a poll which measures an expectation degree and requirements of the selected type of business and field to the consumer through a consumer/cooperative company auction proceeding module to the corresponding consumer; a fourth step of comparing the poll created by the consumer in the third step and the PR information of the provider which is created as a DB in the second step through a first matching degree module to determine a matching degree; a fifth step of, when the matching degree between an arbitrary consumer and the provider is determined in the fourth step, providing information only on providers having a matching degree of a predetermined reference value or above to the consumer through the consumer/cooperative company auction proceeding module; a sixth step of submitting a bidding request document for a service of interest through the consumer input module by a consumer which receives information of the providers having a matching degree of a predetermined reference value or above in the fifth step; a seventh step of providing the bidding document of the consumer which is submitted through the sixth step only to a provider having a matching degree of a predetermined reference value or above in the fifth step, through the consumer/cooperative company auction proceeding module; an eighth step of providing tender details on the basis of the bidding document through the cooperative company input module, by the providers which receive the bidding document of the consumer in the seventh step; and a ninth step of providing information on tender details of the consumer through the consumer/cooperative company auction proceeding module and the second matching degree calculating module so as to allow the consumer to receive a tender request and determine a tender subject and tender details.

In an exemplary embodiment of the present invention, preferably, the method may further include: a potential client informing step of, when the arbitrary consumer (netizen) accesses to select a type of business and a field of interest through the third step, posting that there is a potential client together with informal information of the potential client through an informal consumer information board to allow the provider to read the board.

In an exemplary embodiment of the present invention, preferably, the method may further include: a provider-side bidding step of obtaining the information posted through the potential client informing step to provide the PR information of the provider and bidding details to the potential client by the service provider.

In an exemplary embodiment of the present invention, preferably, the method may further include: a hospital-side bidding step of obtaining the information posted through the potential client informing step to provide the PR information of the provider and bidding details to the potential client by the service provider; and a client tender step of tendering to the hospital through the consumer/cooperative company auction proceeding module by the potential client which receives the PR information of the arbitrary provider and the bidding details through the hospital-side bidding step.

### Effect

According to the suggested exemplary embodiment, a matching degree is calculated on the basis of various matters, such as a consumer's taste or requirements and a provider's merit or supply history, among matters irrespective of price and a consumer and a provider having a matching degree of a predetermined reference value or above are connected. In this case, the consumer side provides a bidding document to only providers having the matching degree of the predetermined reference value or above and compares the bidding document with a corresponding bid document so as to allow making a choice considering a cost and a service.

### DESCRIPTION OF DRAWINGS

FIG. 1 is an exemplary flow chart explaining for a service relay method considering a matching degree according to the present invention.

FIG. 2 is an exemplary flow chart explaining for another exemplary embodiment of a service relay method considering a matching degree according to the present invention.

FIG. 3 is an exemplary view of a configuration of a server system for supporting a service relay method considering a matching degree according to the present invention.

### DETAILED DESCRIPTION OF THE EMBODIMENT

Hereinafter, a service relay method considering a matching degree according to the present invention will be described in detail with reference to the accompanying drawings.

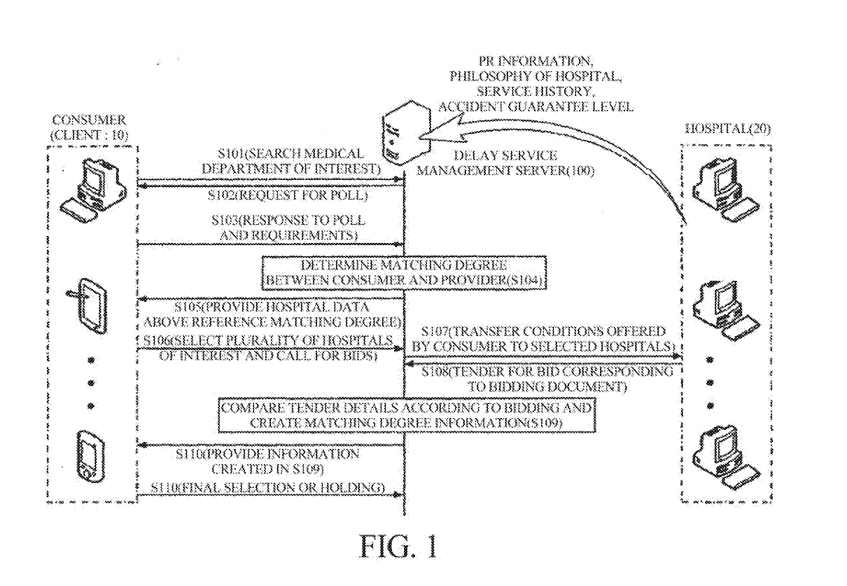

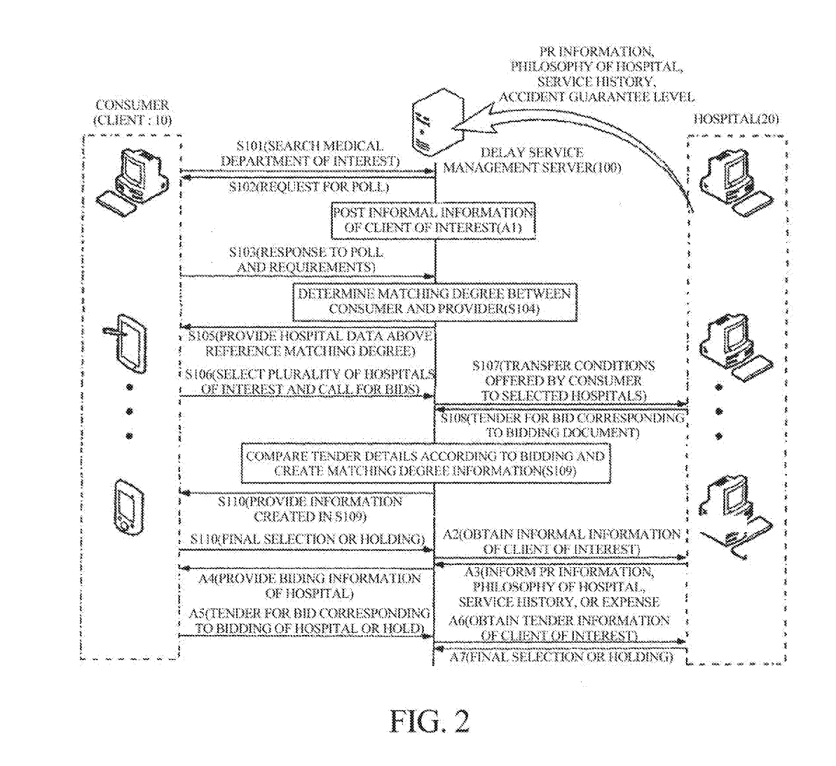

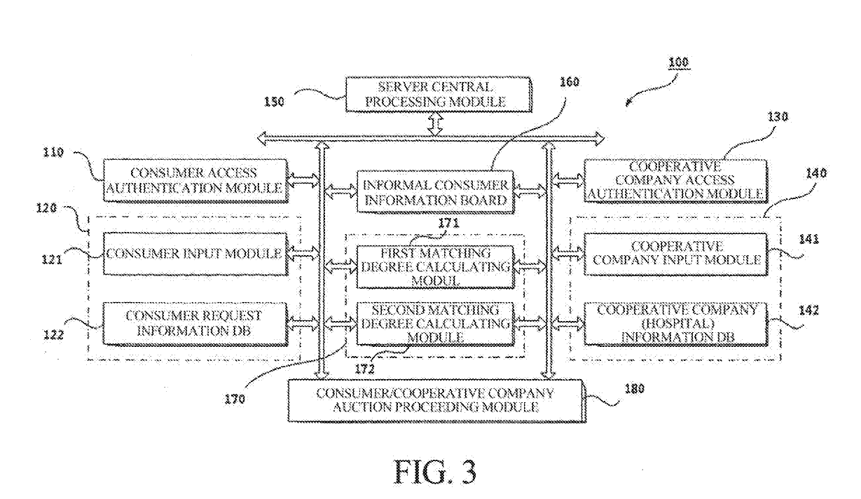

FIG. 1 is an exemplary flow chart explaining for a service relay method considering a matching degree according to the present invention, FIG. 2 is an exemplary flow chart explaining for another exemplary embodiment of a service relay method considering a matching degree according to the present invention, and FIG. 3 is an exemplary view of a configuration of a server system for supporting a service relay method considering a matching degree according to the present invention. The present invention is made to connect all service providers and consumers. However, for the convenience of description, a medical service is described as an example as illustrated in FIG. 1.

As illustrated in FIGS. 1 and 3, the present invention relates a relay service providing method between specific service providers on the basis of on-line and a consumer which receives a service provided by an arbitrary provider and a medical service is described as an example.

First, referring to FIG. 3, a configuration of a management server 100 which performs a service according to the present invention includes a consumer access authentication module 110 which, when a consumer (netizen) requests Internet access using a terminal (hereinafter, referred to as a consumer terminal) of the consumer, approves the access of the consumer terminal and maintains an access state to perform bidirectional data communication, a consumer management module 120 which allows inputting consumer information including poll/requirements in the management server 100 through the consumer terminal which is accessed to the consumer access authentication module 110, a cooperative company access authentication module 130 which, when a provider (hospital) requests Internet access using a terminal (hereinafter, referred to as a provider terminal) of the provider, approves the access of the provider terminal and maintains an access state to perform bidirectional data communication, a cooperative company management module 140 which allows inputting cooperative company information including PR information in the management server 100 through the provider terminal which is accessed to the cooperative company access authentication module 130, a matching module 170 which compares information stored in the consumer management module 120 and the cooperative company management module 140 to calculate a matching degree, a consumer/cooperative company auction proceeding module 180 which performs bidding and tendering for bid in accordance with an auction procedure on the basis of the information of the consumer management module 120, the cooperative company management module 140, and the matching module 170, and a server central processing module 150 which controls operations of the above-described components and a flowing direction of data.

Additionally, the management server 100 may further include an informal consumer information board 160 on which informal information on the requirements of the consumer is posted. The consumer management module 120 and the cooperative company management module 140 are configured by input modules 121 and 141 for inputting data and information DBs 122 and 142 which store information of the consumer and the cooperative company, respectively.

Further, referring to FIGS. 1 and 2, the consumer (client) which is denoted by reference numeral 10 refers to a terminal which is practically accessible to the Internet as illustrated in the drawing. The provider (hospital) which is denoted by reference numeral 20 also refers to a terminal which is accessible to the Internet.

Therefore, it is clarified that throughout the detailed description of the present invention, when it is referred to as a consumer or a provider, it means a consumer terminal or a provider terminal.

Therefore, the management server 100 which manages a relay service according to the present invention needs to preferentially perform a process of making an agreement with a plurality of providers of every type of business in every field. By doing this, the management server 100 obtains PR information on a service which is provided to providers (20: hospitals) with whom the agreement is made to create databases.

To this end, the cooperative companies are collected as members through the cooperative company access authentication module 130. In this case, only a member who agrees with a service contract according to the present invention at the time of joining as a member is authenticated as a regular member.

Therefore, PR information on a service which is provided to providers with whom the agreement is made through the cooperative company access authentication module 130 and information on the cooperative company according to the agreement are obtained through a cooperative company input module 141 to be created as databases in the cooperative company information DB 142.

When an arbitrary consumer (10: netizen) accesses the consumer access authentication module 110 to select a type of business and a field of interest in step S101 after completing the above-described preceding processes, a poll which may measure an expectation degree and requirements of the selected type of business and field is requested to the corresponding consumer 10 through a consumer/cooperative company auction proceeding module 180 in step S102.

When a response to the poll which is made by the consumer 10 through step S102 is collected through step S103, a first matching degree calculating module 171 goes to step S104 to compare the PR information of the provider which is created as a database using information of the provider (20: hospital) which is collected in the preceding process and poll response information to determine a matching degree.

Next, when the matching degree between the consumer 10 and the provider 20 is determined using the matching information of step S104, only information of the providers 20 having a matching degree of a predetermined reference value or above is provided to the consumer 10 through step S105.

The consumer 10 which receives information of the providers 20 having a matching degree of a predetermined reference value or above through step S105 submits a bidding request document for a service of interest through step S108. In this case, the consumer may select a plurality of providers (20: hospitals).

The bidding document of the consumer 10 which is submitted through step S106 is provided only to a provider 20 having a matching degree of a predetermined reference or above through step S104 or only to a provider 20 which is selected at the time of creating the bidding document of step S106 in step S107.

The providers 20 which receive the bidding document of the consumer 10 through step S107 provide tender details according to the bidding document through step S108. The management server 100 creates comparison details of information on the tender details corresponding to the bidding of the consumer 10 and information representing a detailed matching degree through step S109 to allow the consumer 10 to receive a tender request of the hospital 20 which is provided through step S108 and determine a tender subject and tender details.

The comparison of the tender details according to the bidding in step S109 is performed through the consumer/cooperative company auction proceeding module 180 and the detailed matching degree is calculated through the second matching degree calculating module 172.

The information created in step S109 is finally provided to the consumer 10 through step S110 and the consumer 10 finally makes selection or holds the selection on the basis of information provided through step S110 in step S110.

In this case, when the final selection is made in step S110, a general contract performance process is performed thereafter, which will be omitted.

Another exemplary embodiment illustrated in FIG. 2 which is different from the above-described exemplary embodiment relates to a bidirectional auction method and further includes a process of requesting a bidding by a hospital 20 to the client.

When another exemplary embodiment of the present invention is described with reference to FIG. 2, in the exemplary embodiment illustrated in FIG. 2, the preceding processes are same as those of FIG. 1.

That is, the management server 100 needs to preferentially perform a process of making an agreement with a plurality of providers of every type of business in every field. By doing this, the management server 100 obtains PR information on a service which is provided to providers (20: hospitals) with whom the agreement is made to create databases.

When an arbitrary consumer (10: netizen) accesses the consumer access authentication module 110 to select a type of business and a field of interest in step S101 after completing the above-described preceding processes, the management server 100 requests a poll which may measure an expectation degree and requirements of the selected type of business and field to the consumer 10 in step S102.

In this case, the management server 100 posts that there may be potential clients who are interested in an arbitrary field through step A1, during step S102. In this case, the posted contents are informal information which is maintained at an appropriate level to prevent leakage of information.

When a response to the poll which is made by the consumer 10 through step S102 is collected through step S103, the management server 100 goes to step S104 to compare the PR information of the provider which is created as a database using information of the hospital 20 which is collected in the preceding process and poll response information to determine a matching degree.

Next, when the matching degree between the consumer 10 and the provider 20 is determined using the matching information of step S104, only information of the providers 20 having a matching degree of a predetermined reference value or above is provided to the consumer 10 through step S105.

The consumer 10 which receives information of the providers 20 having a matching degree of a predetermined reference value or above through step S105 submits a bidding request document for a service of interest through step S108. In this case, the consumer may select a plurality of providers 20 (hospitals).

The bidding document of the consumer 10 which is submitted through step S106 is provided only to a provider 20 having a matching degree of a predetermined reference or above through step S104 or only to a provider 20 which is selected at the time of creating the bidding document of step S106 in step S107.

The providers 20 which receive the bidding document of the consumer 10 through step S107 provide tender details according to the bidding document through step S108. The management server 100 creates information of the tender details corresponding to the bidding of the consumer through step S109 to allow the consumer 10 to receive a tender request and determine a tender subject and tender details.

The information created in step S109 is finally provided to the consumer 10 through step S110 and the consumer 10 finally makes selection or holds the selection on the basis of information provided through step S110 in step S110.

In this case, when the final selection is made in step S110, a general contract performance process is performed thereafter, which will be omitted.

When the final selection is not performed in step S110 or the consumer 10 does not bid during the above-described step so that the service relay is not performed, the hospital 20 may obtain information of the potential client which is posted through step A2 and provide PR information of the hospital 20 and call for bid (to inform a service expense) through step A3.

Therefore, the management server 100 transmits information which is generated by the hospital 20 through step A3 to the consumer 10 through step A4 and the consumer 10 may tender for bid corresponding to bidding details or hold through step A5.

When the consumer 10 tenders for bid, the tender details of the consumer is provided to the hospital through step A6.

Therefore, the hospital 20 may finally select or hold on the basis of the information provided through step A6 in step A7.

In this case, when the final selection is made in step A7, a general contract performance process is performed thereafter, which will be omitted.

In addition, preferred embodiments of the present invention have been illustrated and described above, but the present invention is not limited to the above-described specific embodiment, it is obvious d that various modification may be made by those skilled in the art, to which the present invention pertains without departing from the gist of the present invention, which is claimed in the claims, and such modified embodiments should not be individually understood from the technical spirit or prospect of the present invention.

1. A service relay system considering a matching degree which provides a service between specific service providers and a consumer who receives a service provided by an arbitrary provider through a management server, on the basis of on-line, the system comprising:
a consumer access authentication module which, when a consumer (netizen) requests Internet access using a terminal (hereinafter, referred to as a consumer terminal) of the consumer, approves the access of the consumer terminal and maintains an access state to perform bidirectional data communication;
a consumer management module which allows inputting consumer information including poll/requirements in the management server through the consumer terminal which is accessed to the consumer access authentication module;
a cooperative company access authentication module which, when a provider requests Internet access using a terminal (hereinafter, referred to as a provider terminal) of the provider, approves the access of the provider terminal and maintains an access state to perform bidirectional data communication;
a cooperative company management module which allows inputting cooperative company information including PR information in the management server through the provider terminal which is accessed to the cooperative company access authentication module;
a matching module which compares information stored in the consumer management module and the cooperative company management module to calculate a matching degree;
a consumer/cooperative company auction performing module which performs bidding and tendering for bid in accordance with an auction procedure on the basis of the information of the consumer management module, the cooperative company management module, and the matching module; and
a server central processing module which controls operations of the consumer management module, the cooperative company management module, the matching module, and the consumer/cooperative company auction proceeding module and a flowing direction of data.

2. The system according to claim 1, further comprising:
an informal consumer information board on which informal information on the requirements of the consumer is posted.

3. The system according to claim 1, wherein the consumer management module and the cooperative company management module are configured by:
an input module for inputting data; and
an information DB for storing information of the consumer and the cooperative company.

4. The system according to claim 1, wherein the matching module includes:
a first matching degree calculating module which calculates a matching degree on the basis of information stored in the consumer management module and information stored in the cooperative company management module; and
a second matching degree calculating module which calculates a matching degree of detailed information in accordance with bidding details when a request according to bidding is generated by the consumer or the cooperative company.

5. A service relay method considering a matching degree which provides a relay service between specific service providers and a consumer who receives a service provided by an arbitrary provider, on the basis of on-line, the method comprising;
a first step of making an agreement with a plurality of providers of every type of business in every field by contract in accordance with member joining through terminals which are used by the providers and a cooperative company access authentication module;
a second step of obtaining PR information on a service which is provided to providers with whom the agreement is made through the first step and information on the cooperative company according to the agreement through the terminals which are used by the providers and the cooperative company input module to be created as databases in a cooperative company information DB;
a third step of when an arbitrary consumer (netizen) accesses through the terminal which is used by the consumer and the consumer access authentication module and then select a type of business and a field of interest through the consumer input module, requesting a poll which measures an expectation degree and requirements of the selected type of business and field to the consumer through a consumer/cooperative company auction proceeding module to the corresponding consumer;
a fourth step of comparing the poll created by the consumer in the third step and the PR information of the provider which is created as a DB in the second step through a first matching degree module to determine a matching degree;
a fifth step of, when the matching degree between an arbitrary consumer and the provider is determined in the fourth step, providing information only on providers having a matching degree of a predetermined reference value or above to the consumer through the consumer/cooperative company auction proceeding module;
a sixth step of submitting a bidding request document for a service of interest through the consumer input module by a consumer which receives information of the providers having a matching degree of a predetermined reference value or above in the fifth step;
a seventh step of providing the bidding document of the consumer which is submitted through the sixth step only to a provider having a matching degree of a predetermined reference value or above in the fifth step, through the consumer/cooperative company auction proceeding module;
an eighth step of providing tender details on the basis of the bidding document through the cooperative company input module, by the providers which receive the bidding document of the consumer in the seventh step; and
a ninth step of providing information on tender details of the consumer through the consumer/cooperative company auction proceeding module and the second matching degree calculating module so as to allow the consumer to receive a tender request and determine a tender subject and tender details.

6. The method according to claim 5, further comprising:
a potential client informing step of, when the arbitrary consumer (netizen) accesses to select a type of business and a field of interest through the third step, posting that there is a potential client together with informal information of the potential client through an informal consumer information board to allow the provider to read the board.

7. The method according to claim 5, further comprising;
a provider-side bidding step of obtaining the information posted through the potential client informing step to provide the PR information of the provider and bidding details to the potential client by the service provider.

8. The method according to claim 5, further comprising:
a hospital-side bidding step of obtaining the information posted through the potential client informing step to provide the PR information of the provider and bidding details to the potential client by the service provider; and
a client tender step of tendering to the hospital through the consumer/cooperative company auction proceeding module by the potential client which receives the PR information of the arbitrary provider and the bidding details through the hospital-side bidding step.

9. The method according to claim 6, further comprising;
a provider-side bidding step of obtaining the information posted through the potential client informing step to provide the PR information of the provider and bidding details to the potential client by the service provider.

10. The method according to claim 6, further comprising:
a hospital-side bidding step of obtaining the information posted through the potential client informing step to provide the PR information of the provider and bidding details to the potential client by the service provider; and
a client tender step of tendering to the hospital through the consumer/cooperative company auction proceeding module by the potential client which receives the PR information of the arbitrary provider and the bidding details through the hospital-side bidding step.
